(19) United States
(12) Patent Application Publication
(10) Pub. No.: US 2024/0390217 A1
(43) Pub. Date: Nov. 28, 2024

(54) SYSTEM AND METHOD FOR CUFF PRESSURE CONTROL

(71) Applicant: Innovation Lab, LLC, Brea, CA (US)

(72) Inventors: Meghan Elizabeth Kieninger, Cumming, GA (US); Steve Han, Fountain Valley, CA (US); Nikolas Pourghahreman, La Palma, CA (US)

(21) Appl. No.: 18/673,023

(22) Filed: May 23, 2024

Related U.S. Application Data
(60) Provisional application No. 63/468,535, filed on May 24, 2023.

(51) Int. Cl. A61H 9/00

(52) U.S. Cl. CPC A61H 9/0092; A61H 2201/0103; A61H 2201/1238; A61H 2201/165; A61H 2201/5007; A61H 2201/5071; A61H 2205/06; A61H 2205/10; A61H 2205/12

(57) ABSTRACT

A limb occlusion cuff for use in a compression system comprises an inflatable bladder, a variable orifice valve coupled to the inflatable bladder via a fluid pathway, a pump coupled to the inflatable bladder via the fluid pathway, a pressure sensor disposed along the fluid pathway, and controller, the controller comprising a processor configured to actively regulate a current pressure in the inflatable bladder. A method of actively regulating pressure in a limb occlusion cuff of a compression system and performed by a controller of the cuff comprises determining a target pressure in an inflatable bladder of the cuff, receiving, from a pressure sensor of the cuff, a signal indicative of a current pressure in the inflatable bladder, and comparing, via a processor of the controller, the current pressure in the inflatable bladder to the target pressure.

### CROSS-REFERENCE TO RELATED APPLICATION

This application claims the benefit of priority of U.S. Provisional Application No. 63/468,535, filed May 24, 2023, the contents of which are hereby incorporated by reference herein.

### TECHNICAL FIELD

The present application relates to systems and methods for cuff pressure control. More specifically, the present application relates to systems and methods for cuff pressure controller for blood flow restriction devices and other medical or therapeutic devices that apply pressure to certain portions of the human body for purposes of vessel occlusion.

### BACKGROUND

Pressure cuffs have a wide range of applications in the medical, therapeutic, and wellness fields. The most well-known application is the blood pressure (BP) cuff. However, pressure cuffs are also used in various other applications, for example, as blood flow restriction (BFR) devices for compression therapy and for endotracheal tubes for intubation. In BP cuffs, once above systole, pressure data collected during inflation and/or deflation of the cuff is used to determine, for example, systolic and diastolic pressures of the user.

Traditional pressure cuffs operate by inflating to a pressure sufficient to partially or completely occlude a user's arterial blood flow, or to a pressure above a user's limb occlusion pressure. In general, the limb occlusion pressure may be a pressure exerted on the limb by the cuff that is sufficient to completely restrict arterial blood flow within the limb, thereby inducing an anaerobic environment in the user's muscle in the limb (e.g., a limb occlusion cuff may be affixed to the arm of a user to establish an anaerobic environment within the user's bicep).

In particular, a cuff can comprise a bladder that is configured to inflate, such that the cuff containing the bladder is forced to expand. The expansion of the bladder within a cuff can cause the cuff to exert a force along the entire circumference of the limb to which the cuff is affixed. In compression therapy, the bladder is inflated to a size such that the cuff exerts a certain (e.g., fixed) percentage of an occlusion pressure of the limb to which the cuff is affixed. The resulting pressure exerted by the cuff on a user's limb restricts the flow of blood within the limb and establishes an anaerobic environment in the muscle of the limb. Training a muscle in which such an anaerobic environment has been established by a limb occlusion cuff is sometimes referred to as BFR training. Training a muscle in which such an anaerobic environment has been induced increases the perceived load moved by the muscle. For example, BFR training using a cuff and a lighter load can elicit metabolic responses in the muscle equivalent to that which may be experienced by training the same muscle absent the therapy cuff, but with a heavier load. As such, the use of compression therapy cuffs for BFR training can be used, for example, for rehabilitation of injured patients, who need to work on mobility, but cannot lift heavy loads.

One drawback in using traditional pressure cuffs is the difficulty in applying and maintaining a desired, optimal and/or beneficial amount of pressure on the limb of a user throughout the duration of a user session (e.g., during contracting and relaxing one or more muscles). Such a task is further complicated in use cases in which flexion (e.g., contracting) and extension (e.g., relaxing) of the user's muscles apply forces to the cuff and cause changes in the pressure in the cuff. Such changes in pressure in the cuff affect the pressure applied to the user's limb (e.g., including one or more associated muscles, blood vessels, etc.) by the cuff so that the pressure applied to the user's limb by the cuff may be above or below the desired, optimal and/or beneficial pressure applied to the user's limb. Such pressures above or below the desired, optimal and/or beneficial applied pressure can either cause damage to the associated limb (e.g., damage to one or more associated and/or adjacent muscle, blood vessel, etc.) or result in the cuff being ineffective for its intended purpose.

### SUMMARY

The present application discloses a limb occlusion cuff for use in a compression system and a method of actively regulating pressure in a limb occlusion cuff of a compression system. In an embodiment, a limb occlusion cuff comprises an inflatable bladder. The limb occlusion cuff can further comprise a variable orifice valve coupled to the inflatable bladder via a fluid pathway. The limb occlusion cuff can further comprise a pump coupled to the inflatable bladder via the fluid pathway. The limb occlusion cuff can further comprise a pressure sensor disposed along the fluid pathway. The limb occlusion cuff can further comprise a controller. The controller of the limb occlusion cuff can further comprise a processor configured to actively regulate a current pressure in the inflatable bladder.

In certain embodiments, the limb occlusion cuff further comprises a pressure sensor configured to generate a signal indicative of the current pressure of the inflatable bladder. In further embodiments, the limb occlusion cuff further comprises a processor configured to perform a comparison between the current pressure of the inflatable bladder and a target pressure of the inflatable bladder. In some embodiments, the limb occlusion cuff further comprises a processor configured to actively regulate the current pressure by controlling the variable orifice valve to release fluid to deflate the inflatable bladder if the result of the comparison indicates that the current pressure is greater than the target pressure.

In certain embodiments, the processor is configured to actively regulate the current pressure by controlling the pump to intake fluid to inflate the inflatable bladder if the result of the comparison indicates that the current pressure is lower than the target pressure. In some embodiments, the processor is configured to actively regulate the current pressure by simultaneously controlling the variable orifice valve to release fluid and/or controlling the pump to intake fluid until the current pressure of the bladder is substantially equal to the target. In further embodiments, the variable orifice valve comprises a proportional valve, and in certain embodiments, the proportional valve is coupled bi-directionally to the inflatable bladder.

In some embodiments, the target pressure of the inflatable bladder is chosen such that a pressure exerted by the limb occlusion cuff on a limb of a user is below an occlusion pressure of a limb of the user. In certain embodiments, pressure exerted by the limb occlusion cuff on the limb of the user is between thirty percent and eighty percent of the limb occlusion pressure of the limb of the user. In further embodiments, the pressure exerted by the limb occlusion cuff on the limb of the user is between thirty percent and fifty percent of the limb occlusion pressure of the limb of the user. In certain embodiments, the pressure exerted by the limb occlusion cuff on the limb of the user is between fifty percent and eighty percent of a limb occlusion pressure of the limb of the user.

In some embodiments, the variable orifice valve is configured to always be at least partially open during use of the limb occlusion cuff, and the pump is configured to always be on during use of the limb occlusion cuff. In further embodiments, the controller further comprises a memory, and the target pressure is stored in the memory.

In certain embodiments, the processor is configured to actively regulate the current pressure by closed-loop control.

In an embodiment, a method of actively regulating pressure in a limb occlusion cuff, the limb occlusion cuff comprising an inflatable bladder, a variable orifice valve coupled to the inflatable bladder via a fluid pathway, a pump coupled to the inflatable bladder via the fluid pathway, a pressure sensor disposed along the fluid pathway, and a controller, the method performed by the controller, comprises determining a target pressure in the inflatable bladder. The method further comprises receiving, from the pressure sensor, a signal indicative of a current pressure in the inflatable bladder. The method additionally comprises comparing, via a processor of the controller, the current pressure of the inflatable bladder to the target pressure.

In certain embodiments, the method further comprises, when the comparing indicates that the current pressure in the inflatable bladder exceeds the target pressure, signaling, via the controller, the variable orifice valve to vent fluid from the inflatable bladder. In some embodiments, the method further comprises, when the comparing indicates that the current pressure in the inflatable bladder is less than the target pressure, signaling, via the controller, the pump to draw fluid into the inflatable bladder.

In further embodiments, the method further comprises venting fluid from the inflatable bladder via a proportional valve, the proportional valve being bi-directionally coupled to the inflatable bladder. In certain embodiments, the method further comprises comparing, via the processor of the controller, the current pressure in the inflatable bladder to the target pressure, the target pressure being chosen so that the limb occlusion cuff exerts a pressure on a limb of a user that is below an occlusion pressure of the limb of the user.

In some embodiments, the method further comprises keeping the variable orifice valve always at least partially open and/or keeping the pump always on during use of the limb occlusion cuff. In further embodiments, the method further comprises drawing fluid in through the pump when a user of the limb occlusion cuff flexes a muscle adjacent to the cuff, and venting fluid out through the variable orifice valve when the user of the limb occlusion cuff extends the muscle adjacent to the cuff.

The details of one or more variations of the subject matter described herein are set forth in the accompanying drawings and the description below. Other features and advantages of the subject matter described herein will be apparent from the description and drawings, and from the claims.

### BRIEF DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a schematic diagram of a compression system in accordance with one embodiment;

FIG. 2 illustrates a schematic diagram of a compression system with an accumulator in accordance with another embodiment;

FIG. 3 illustrates an active pressure simulation graph in accordance with an exemplary embodiment;

FIG. 4 shows a flowchart illustrating a process for controlling a pressure inside of a limb occlusion cuff in accordance with some example embodiments;

FIG. 5 illustrates a schematic diagram of a hydraulic compression system in accordance with another embodiment;

FIG. 6 illustrates a schematic diagram of a hydraulic compression system with an accumulator in accordance with another embodiment;

FIG. 7 illustrates an exemplary manner in which a compression system can be disposed on a limb of a user; and

FIGS. 8A-8C illustrate an exemplary variable orifice valve in accordance with some example embodiments.

When practical, similar reference numbers denote similar structures, features, or elements.

### DETAILED DESCRIPTION

Described herein are various embodiments and related methods of compression systems (also referred to herein as blood flow restriction devices, or BFRs) that are effective for actively controlling an amount of applied pressure to a limb of a user in order to appropriately restrict blood flow along at least a part of the limb. Such active control of the amount of pressure to restrict blood flow can be performed during various levels of resistance training intensity (including low intensity) to increase muscle mass along the limb. Additionally, BFRs can be used to treat various muscular, intravenous, and nervous system deficiencies. Wearable compression systems may be used for therapeutic and strength training purposes. For example, in orthopedics, non-surgical and post-surgical conditions may benefit from blood flow restriction therapy using the wearable compression system, such as to shorten recovery time and reduce muscle loss (atrophy) by allowing a user to exercise under a perceived increased load while reducing the potential for injury that arises from exercising under a heavy load.

Ensuring that a limb occlusion cuff applies a constant or near-constant pressure on a limb to which the limb occlusion cuff is affixed, regardless of the force of muscle of the user in the BFR, can prevent injury and discomfort, as well as heighten the therapeutic effects of the device. For example, applied pressure that is too high along a limb can result in injury and/or damage to tissue (e.g., muscles, nerves, vasculature) at and/or adjacent to the location where the pressure was applied. Also, an applied pressure that is too low does not allow the limb occlusion cuff to perform effectively for its intended purpose (e.g., restricting blood flow to within a desired blood flow range and/or restricting blood pressure along one or more blood vessels to within a desired blood pressure range for a desired duration of time to thereby achieve the desired increase in muscle mass), such that the user is unable to obtain the intended user benefits.

The present disclosure describes various embodiments of a compression system and method to actively control (e.g., continuously maintain) a pressure and/or range of pressures applied to a limb. For example, the compression system can include a limb occlusion cuff that is configured to secure to the limb and apply the pressure to the limb to within a desired pressure range (e.g., a range of pressures that, when applied to the limb associated with the limb occlusion cuff, does not result in injury and/or damage to the limb, as well as allows the limb occlusion cuff to perform effectively for its intended purpose). More specifically, the present compression system and related methods can continuously maintain a constant desired pressure and/or desired pressure range applied by the limb occlusion cuff regardless of the force exerted by a user's muscle on the limb occlusion cuff during use. The present compression system and related methods can be configured to actively and continuously maintain a desired pressure range, the range including a desired percentage of an occlusion pressure for a limb to which the system is secured or affixed, the limb occlusion pressure being the pressure that would need to be applied to a limb to completely restrict the flow of blood within the limb, and/or within a portion of the limb distal to the location of the limb at which the cuff is affixed.

In some embodiments, the compression system can include a processor that can actively regulate (e.g., continuously regulate) the pressure applied by the limb occlusion cuff. In certain embodiments, the processor can actively regulate the pressure applied by the limb occlusion cuff via closed-loop control. In further embodiments, the processor can actively regulate the pressure applied by the limb occlusion cuff by varying a size of an orifice of a variable orifice valve of the limb occlusion cuff so as to release fluid from the limb occlusion cuff. As described herein, the processor can actively vary the size of the orifice of the variable orifice valve based on a difference between a current pressure in a bladder of the limb occlusion cuff and a target pressure of the bladder of the limb occlusion cuff.

In some embodiments, the variable orifice valve can be a proportional valve. In certain embodiments, the processor can variably control a solenoid within the proportional valve so that a piston moves relative to the orifice of the proportional valve, thereby controlling an amount of fluid that is able to pass through the proportional valve. For example, the processor can control the solenoid to vary the position of the piston such that the orifice is maintained at least partially open during use of the limb occlusion cuff. As such, during use, the proportional valve can be maintained in at least a partially open state.

In some embodiments, the compression system can include a pump or fluid source that can assist with actively regulating the pressure in the limb occlusion cuff. In certain embodiments, processor of the compression system can actively regulate (e.g., continuously regulate) the pressure applied by the limb occlusion cuff via closed-loop control by varying an amount of fluid drawn in through the pump or fluid of the compression system so as to draw fluid into the limb occlusion cuff. For example, the pump can be maintained actively (e.g., powered on and awaiting instructions from the processor for immediate action, such as supplying fluid to the limb occlusion cuff) during use of the limb occlusion cuff in order to maintain the pressure applied by the limb occlusion cuff within the desired pressure range, including during expansion and contraction of muscles adjacent to or in contact with the limb occlusion cuff. As such, in some embodiments the processor can simultaneously control the orifice of the variable orifice valve (e.g., the processor can control an extent of the cross-section of the orifice of the variable orifice valve that is not obstructed) and control a state of the pump (e.g., maintain the pump in a stand-by, non-pumping state or activate the pump to a pumping state such that fluid is pumped into the limb occlusion cuff). By simultaneously controlling the degree to which the variable orifice valve is open and the control state of the pump, the processor can precisely, actively, and continuously maintain the pressure applied by the limb occlusion cuff on the limb of a user to which the limb occlusion cuff is secured or affixed.

In embodiments, the target pressure of the inflatable bladder corresponds to a pressure or force to be maintained by the limb occlusion cuff (and thereby applied to the limb) during use, and can fall within a range of pressures, the range including a percentage of a limb occlusion pressure value of the user. As discussed above, the limb occlusion pressure value of a user is the necessary pressure that must be exerted on a limb of the user in order to completely restrict arterial blood flow within that limb, or within a portion of that limb distal to the location on the limb to which the limb occlusion cuff is affixed.

For example, the limb occlusion cuff of a compression system as described in embodiments herein may be configured to apply a pressure on a limb of a user between thirty percent, plus or minus five percent, and eighty percent, plus or minus five percent, of the user's limb occlusion pressure. In some embodiments, the target pressure of the inflatable bladder, and the corresponding pressure to be maintained by the limb occlusion cuff during use is between thirty percent, plus or minus five percent, and fifty percent, plus or minus five percent) of the user's limb occlusion pressure. In further embodiments, the target pressure of the inflatable bladder, and the corresponding pressure to be maintained by the limb occlusion cuff during use is between fifty percent, plus or minus five percent, and eighty percent, plus or minus five percent, of the user's limb occlusion pressure. In general, an appropriate pressure to be maintained by the limb occlusion cuff can be selected based on the limb to which the compression system is affixed.

In an embodiment, if the user's limb occlusion pressure is 140 mmHg, the limb occlusion cuff of a compression system as described herein can exert a force on a limb of a user to provide between 65 mmHg and 75 mmHg of pressure on the user's limb (i.e., the limb occlusion cuff of the compression system can exert a force to provide between fifty percent, plus or minus five percent, of the limb occlusion pressure, regardless of the user's muscle activity when wearing the limb occlusion cuff). The target pressure of the inflatable bladder, and the corresponding pressure to be maintained by the limb occlusion cuff during use can be pre-programmed and/or selected by the user so that the user of the limb occlusion cuff experiences an appropriate amount of blood flow restriction in the limb or portion of the limb to which the limb occlusion cuff is affixed.

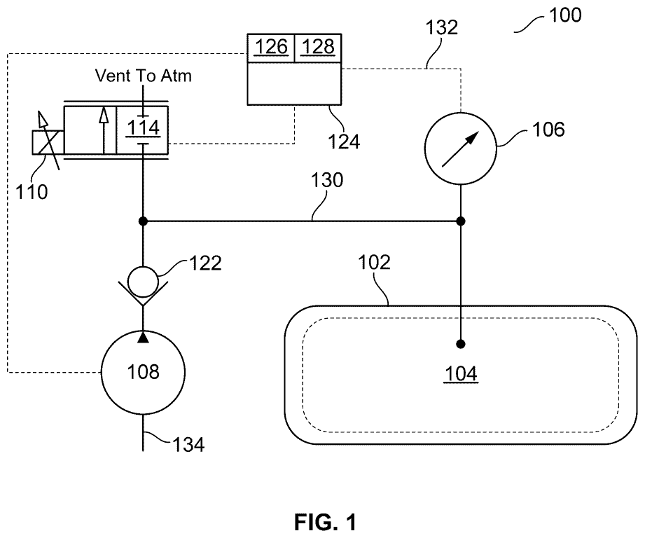

Referring now to FIG. 1, a compression system 100 for controlling pressure applied by a limb occlusion cuff on a limb is shown. In embodiments, the compression system 100 may include an embodiment of the limb occlusion cuff 102 (also referred to herein as cuff 102) having an inflatable and deflatable bladder 104, pressure sensor 106, pump and/or fluid source 108, variable orifice valve 110 and controller 124. Controller 124 of compression system 100 may comprise processor 126 and memory 128. Compression system 100 may be an untethered compression system, such that pump or fluid source 108 draws fluid directly from the atmosphere rather than from a fluid reservoir via a fluid line.

As shown in FIG. 1, limb occlusion cuff 102 and bladder 104 can be in communication with controller 124 via electrical connection line 132 shown as dashed lines. Limb occlusion cuff 102 and inflatable bladder 104 can be coupled with pump or fluid source 108. Controller 124, via processor 126, can be configured to actively control pump or fluid source 108.

As described herein, active control of pump or fluid source 108 by processor 126 refers to control of pump or fluid source 108 such that the pressure exerted on a limb of the user to which limb occlusion cuff 102 is affixed remains sufficiently low so as to ensure safe use of compression system 100, while also ensuring that the pressure remains sufficiently large so as to ensure that a user of compression system 100 experiences the clinical benefits as described above. The pump 108 maintains positive pressurization of the cuff 102 via closed-loop control to ensure that the target pressure of bladder 104 is maintained both during initial pressurization and after venting. Controller 124, via processor 126, can turn pump or fluid source 108 to an active or “on” position to provide fluid flow from atmosphere 134 (or from any appropriate fluid reservoir) to bladder 104 of limb occlusion cuff 102 via pneumatic line 130, thus inflating bladder 104. Controller 124, via processor 126, can similarly turn pump or fluid source 108 to an inactive or “off” position, stopping the flow of fluid from atmosphere 134 (or from any appropriate fluid reservoir) to bladder 104 of limb occlusion cuff 102. In operation, when limb occlusion cuff 102 is coupled to a user's limb, inflation of bladder 104 can cause expansion of limb occlusion cuff 102, such that the pressure applied by limb occlusion cuff 102 on the limb of the user increases. Such an increase in pressure may be sufficient to cause blood flow restriction along at least a portion of the limb of the user. Embodiments as described herein as such actively regulate the pressure of inflatable bladder 104 so that the pressure exerted by limb occlusion cuff 102 on the limb of a user remains within a range including a target pressure. Controller 124, via processor 126, can actively regulate the pressure of inflatable bladder using closed-loop control. As discussed above, the target pressure of inflatable bladder 104 is selected such that limb occlusion cuff 102 exerts a constant pressure on a limb of a user that is a desired percentage of the occlusion pressure of the limb. In some embodiments, the target pressure of inflatable bladder 104 may be selected by the user. Limb occlusion cuff 102 can determine, using the components as described herein, a limb occlusion pressure of a user once the user has affixed limb occlusion cuff 102 to a limb. Based on the determined limb occlusion pressure as determined by limb occlusion cuff 102, a user of limb occlusion cuff 102 may select a target pressure of inflatable bladder 104 such that limb occlusion cuff exerts a desired percentage of the limb occlusion pressure on the limb of the user.

For example, in some embodiments, if it is desired that limb occlusion cuff 102 exerts a pressure equal to fifty percent of the limb occlusion pressure on a limb of a user, then the pressure of bladder 104 is actively regulated so that the pressure exerted by limb occlusion cuff 102 on the limb of a user may be between forty five and fifty five percent of the limb occlusion pressure of the user. In certain embodiments, if it is desired that limb occlusion cuff 102 exerts a pressure equal to thirty five percent of the limb occlusion pressure on a limb of a user, then the pressure of bladder 104 is actively regulated so that the pressure exerted by limb occlusion cuff 102 on the limb of a user may be between thirty two and thirty eight percent of the limb occlusion pressure of the user. In general, the desired limb occlusion pressure and the corresponding pressure range in which the pressure exerted by limb occlusion cuff on the limb of the user falls may be selected such that the user of compression system 100 receives the clinical benefits discussed above, regardless of the limb to which compression system 100 is affixed.

One or more pressure sensors 106 can be in communication with both bladder 104 and controller 124. In some embodiments, the pressure sensor 106 can be a transducer. Pressure sensor 106 can be configured to continuously, or approximately continuously, generate a signal as a function of the current pressure of bladder 104. As discussed above, changes in pressure in bladder 104 cause the pressure applied by limb occlusion cuff 102 on a limb to change, so by providing signals regarding the sensed pressure of bladder 104 to controller 124, real-time (or approximately real-time) values of the pressure applied by limb occlusion cuff 102 on a limb of a user by continuously (or approximately continuously) are determined.

Controller 124 is configured to compare the current pressure of bladder 104 associated with each such signal to the target pressure of bladder 104, the target pressure of bladder 104 being the pressure needed for limb occlusion cuff 102 to exert the desired percentage of the limb occlusion pressure on a limb of the user. Controller 124 is configured to perform such comparisons at a substantially similar frequency to the rate of generation of the signals by pressure sensor 106. In some embodiments, pressure sensor 106 can be configured to generate such a signal indicative of a current pressure in bladder 104 between hundreds of times per second and thousands of times per second. In some embodiments, pressure sensor 106 is configured to generate a signal indicative of the current pressure of bladder 104 approximately 200 times per second. In some embodiments, pressure sensor 106 can be configured to generate a signal indicative of the current pressure in bladder 104 between 100 and 2,000 times per second. In some embodiments, pressure sensor 106 can be configured to generate a signal indicative of the current pressure in bladder 104 between 500 and 1,000 times per second. In certain embodiments, based on the result of the comparisons, processor 126 of controller 124 is configured to instruct either or both of pump or fluid 108 and variable orifice valve 110 so as to adjust the pressure of inflatable bladder 104. The adjustments of the pressure of inflatable bladder 104 cause limb occlusion cuff 102 to exert a pressure within a desired pressure range on the limb of the user. As discussed above, the desired pressure range may include a pressure that is a percentage of a desired occlusion pressure of the limb of the user.

Pump or fluid source 108 can be coupled to pressure sensor 106 and bladder 104. Pump or fluid source 108 can be controlled by the controller 124. In certain embodiments, pump or fluid source 108 can be controlled by the controller 124 via closed-loop control. In some embodiments, a check valve 122 can be positioned proximate the pump 108 on the pneumatic line 130. Check valve 122 can be configured to allow a one-way flow of fluid into compression system 100 to inflate bladder 104 of limb occlusion cuff 102. In certain embodiments, variable orifice valve 110 may be self-sealing and may thus obviate the need for check valve 122.

Variable orifice valve 110 can be coupled with or in communication with each of pump 108, controller 124, pressure sensor 106, and bladder 104. Variable orifice valve 110 can be a proportional valve. Proportional valve 110 can have solenoid or solenoids 112. Proportional valve 110 may further comprise a vent 114. Variable orifice valve 110 is configured to provide variable fluid outputs proportional to an electric input signal in direction, flow, or pressure. Variable orifice valve 110, which can be a proportional valve, can be configured to open or close to a degree proportional to an input voltage, or to a degree proportional to an input voltage represented by a signal sensed by pressure sensor 106. In embodiments, solenoid or solenoids 112 of the variable orifice valve 110, which themselves can include a coil and armature, have an infinite number of positions and can be configured to adjust the flow volume of the fluid based on the signals received from the controller 124, pressure sensor 106, or both. In response to the signal sensed by pressure sensor 106, processor 126 of controller 124 can be configured to adjust variable orifice valve 110 such that the orifice of variable orifice valve 110 is of a sufficient size to release fluid from bladder 104 such that the pressure of bladder 104 falls. As discussed above, inflation and deflation of bladder 104 can cause the pressure exerted by limb occlusion cuff 102 on a limb of a user to vary. Accordingly, the adjustment of solenoid or solenoids 112 of variable orifice valve 110 can be configured such that the pressure exerted by limb occlusion cuff 102 on a limb of a user falls within a desired pressure range, the desired pressure range including a desired percentage of an occlusion pressure of the limb to which compression system 110 is affixed.

As discussed above, controller 124 is configured to compare each the current pressure of bladder 104 associated with each signal generated by pressure sensor 106 to a target pressure of bladder 104, the target pressure of bladder 104 being selected such that limb occlusion cuff 102 exerts the desired percentage of the limb occlusion pressure on a limb of the user. Depending on the result of the comparison, processor 126 of controller 124 can instruct solenoid or solenoids 112 of variable orifice valve 110 to open the orifice of variable orifice valve 110 to an appropriate degree. For example, if a comparison indicates that the current pressure of bladder 104 is too high, such that a large amount of air needs to be released from bladder 104 such that limb occlusion cuff 102 exerts the desired percentage of the occlusion pressure on the limb of a user, then solenoid or solenoids 112 are configured to adjust the orifice of variable orifice valve 110 such that the orifice of variable orifice valve 110 is large. In some embodiments, a large orifice of variable orifice valve 110 may correspond, for example, to between eighty and one hundred percent of the flow pathway defined by variable orifice valve 110 being unobstructed.

Similarly, if a comparison indicates that the only a small amount of air needs to be released from bladder 104 such that limb occlusion cuff 102 exerts the desired percentage of the occlusion pressure on the limb of a user, then solenoid or solenoids 112 are configured to adjust the orifice of variable orifice valve 110 such that the orifice is relatively small. In some embodiments, a small orifice of variable orifice valve 110 may correspond, for example, to between ten and thirty percent of the flow pathway defined by valve 110 being unobstructed. In general, processor 126 continuously and actively instructs solenoid or solenoids 112 to open or close the orifice of variable orifice valve 110 so that the amount of the fluid pathway of variable orifice valve 110 that is unobstructed yields the appropriate amount of fluid being drawn out of bladder 104. By establishing this appropriate fluid flow, the pressure exerted by limb occlusion cuff 102 on a limb of a user falls within the desired pressure range, the range including the desired percentage of the occlusion pressure of the user's particular limb.

The variable orifice valve 110 may be configured so as to always leave at least some portion of the flow pathway of variable orifice valve 110 unobstructed, such that variable orifice valve 110 may be operated in a state where there is at least a minimal amount of flow therethrough. Configuring variable orifice valve 110 so as to always allow at least a minimal amount of fluid flow therethrough makes the current pressure in inflatable bladder 104 easier to adjust, as any desired changes in current pressure of inflatable bladder 104 can be achieved without encountering detrimental characteristics of opening conditions of variable orifice valve 110, including blips or pressure drops due to variable fluid velocity through the variable orifice valve 110. Such a variable orifice valve 110 that is configured to always allow at least a minimal amount of fluid flow therethrough may be said to be in an always-on state.

In operation, variable orifice valve 110 is configured to receive instructions from controller 124, pressure sensor 106, or both, in order to release fluid from bladder 104 to atmosphere 134. Such releasing of fluid from bladder 104 by variable orifice valve 110 reduces the pressure within bladder 104 and can thus help limb occlusion cuff 102 maintain a constant pressure on a limb of a user regardless of the force exerted on limb occlusion cuff 102 by the user's muscle as it flexes and extends.

Pressure sensor 106 can be placed along a pneumatic line 130 between variable orifice valve 110 and bladder 104 at a first distance away from bladder 104. Pressure sensor 106 can further be placed along the pneumatic line 130 between variable orifice valve 110 and bladder 104 such that a second distance between variable orifice valve 110 and pressure sensor 106 is greater than the first distance between pressure sensor 106 and bladder 104 so as to provide an accurate reading of the current pressure in bladder 104, thus facilitating autoregulation of the pressure in limb occlusion cuff 102. Such autoregulation of the pressure in limb occlusion cuff 102 by controller 124 based on information received from pressure sensor 106 can provide clinical benefits to users of compression system 100 as has been described herein.

In embodiments, controller 124 is in communication with processor 126 and memory 128. Processor 126 and memory 128 can control the pressure (e.g., within a desired pressure range) inside of the bladder 104. The pressure range that limb occlusion cuff 102 of compression system 100 seeks to apply to a limb of a user via closed-loop control of the pressure in limb occlusion cuff 102 as described herein can be stored in memory 128. Pressure sensor 108 can be in communication with processor 126. Processor 126 can analyze the pressure data sensed by pressure sensor 106 to determine whether the pressure in bladder 104 should be increased or decreased to achieve a desired amount of applied pressure on the user of limb occlusion cuff 102 for achieving a desired amount of blood flow restriction on the user.

Processor 126 can be programmed to maintain an appropriate pressure in bladder 104 such that the pressure exerted by limb occlusion cuff 102 on a limb of a user during use of cuff 102 remains within a given range, the range including a desired percentage of an occlusion pressure of the limb. Limb occlusion cuff 102 can continuously exert a pressure in this range even though, during use of limb occlusion cuff 102, the user's muscle contractions displace volume of limb occlusion cuff 102. Absent the autoregulating features described herein, such displacement of volume of limb occlusion cuff 102 would cause the pressure in cuff 102 to rise during flexion of the muscle of the limb to which cuff 102 is affixed and fall during extension of the muscle of the limb to which cuff 102 is affixed. As such, to combat this and maintain a constant pressure applied by limb occlusion cuff 102, processor 126 can be programmed to provide signals to the variable orifice valve 110 and pump 108 as described herein.

As described above, a user of limb occlusion cuff 102 may select a target pressure of inflatable bladder 104, the target pressure of inflatable bladder 104 being selected such that limb occlusion cuff 102 exerts a desired percentage of a limb occlusion pressure on a limb of the user. In some embodiments, the target pressure of inflatable bladder 104 is selected such that the pressure maintained by limb occlusion cuff 102 may be a percentage of the limb occlusion pressure of the limb of the user on which limb occlusion cuff 102 is worn. Further, limb occlusion cuff 102 may be configured to maintain a range of pressures, the range of pressures including the desired percentage of a limb occlusion pressure. For example, such a desired percentage of a limb occlusion pressure may be between approximately thirty percent, plus or minus five percent, and eighty percent, plus or minus five percent, of the user's limb occlusion pressure. In some implementations, the desired percentage of the limb occlusion pressure may be between approximately thirty percent, plus or minus five percent, and fifty percent, plus or minus five percent, of the user's limb occlusion pressure. In further implementations, the desired percentage of the limb occlusion pressure may be between approximately fifty percent, plus or minus five percent, and eighty percent, plus or minus five percent, of the user's limb occlusion pressure. As an example, if the user's limb occlusion pressure is 140 mmHg, processor 126 can be configured to signal pump 108, variable orifice valve 110, or both, so that limb occlusion cuff 102 targets an exerted pressure of fifty percent of the limb occlusion pressure, i.e., 70 mmHg. To target such a percentage of the desired limb occlusion pressure, limb occlusion cuff 102 may be configured to exert a pressure between 65 mmHg and 75 mmHg, or between approximately forty-six and fifty percent, of the limb occlusion pressure, on the user's limb.

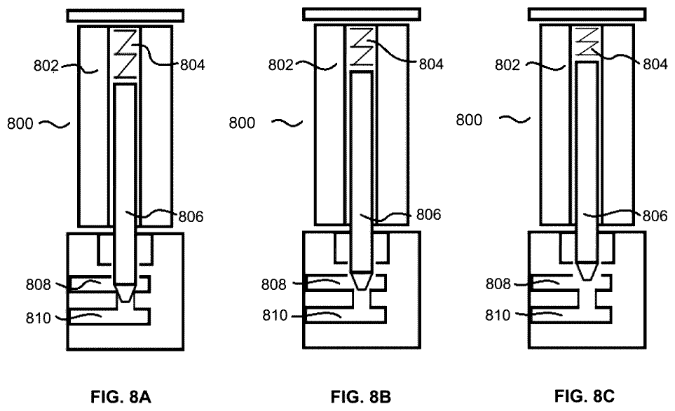

More specifically, in operation, when a user's muscle expands, i.e., upon flexure, the pressure in limb occlusion cuff 102 can increase. Processor 126 can responsively signal variable orifice valve 110 to open to autoregulate the pressure in bladder 104 so that, despite the pressure exerted on limb occlusion cuff 102 by the limb of the user, the pressure exerted by limb occlusion cuff 102 on a limb of the user remains constant at the desired percentage of the limb occlusion pressure of the user. Variable orifice valve 110 can be a proportional valve. Processor 126 can signal proportional valve 110 to open to a degree based on a signal generated by pressure sensor 106, the signal being indicative of the pressure in bladder 104 of the limb occlusion cuff 102. For example, if there is a small difference between the current sensed pressure of bladder 104 and the pressure of bladder 104 necessary so that limb occlusion cuff 102 exerts the desired percentage of the occlusion pressure on a limb, and if the sensed pressure of inflatable bladder 104 is greater than the target pressure of inflatable bladder 104, proportional valve 110 can be configured to open a relatively small amount, as described above. On the other hand, if there is a large difference between the current sensed pressure in bladder 104 and the pressure of bladder 104 necessary so that limb occlusion cuff 102 exerts the desired percentage of the occlusion pressure, and if the sensed pressure of inflatable bladder 104 is greater than the target pressure of inflatable bladder 104, processor 126 can command proportional valve 110 to open to a relatively large amount to vent additional fluid (e.g., air, liquid, etc.) to the atmosphere (or to another appropriate fluid reservoir). For example, the proportional valve 110 can be configured to regulate air passage into and out of the proportional valve 110 using solenoid or solenoids 112, as discussed further below with respect to FIGS. 8A-8C. In certain embodiments, the amount of air released by proportional valve 110 is sufficient to reduce the pressure in bladder 104 such that the pressure exerted by limb occlusion cuff 102 on a limb of the user is within one percent of the desired percentage of the limb occlusion pressure of the limb of the user. In further embodiments, the amount of air released by proportional valve 110 is sufficient to reduce the pressure in bladder 104 such that the pressure exerted by limb occlusion cuff 102 on a limb of the user is within three percent of the desired percentage of the limb occlusion pressure of the limb of the user. In general, the amount of air released by proportional valve 110 can be selected to reduce the pressure in bladder 104 such that the pressure exerted by limb occlusion cuff 102 on a limb of the user is within any desired percent of the desired percentage of the limb occlusion pressure of the limb of the user, the desired percent being selected so that the user of the embodiments described herein experiences the clinical benefits described above.

The compression system 100 can be a closed-loop system in which pressure measurement in limb occlusion cuff 102 controls the opening of variable orifice valve 110. In operation, variable orifice valve 110 can be configured to stay at least partially open during operation. By keeping variable orifice valve 110 continuously at least partially open, pump 108 can operate intermittently or always remain “on” to maintain the target pressure in inflatable bladder 104. By maintaining an always at least partially open variable orifice valve 110 and an always on pump 108, fluid can be drawn into and let out of compression system 100 without incurring delays that would otherwise occur if, e.g., responsive to a reading from pressure sensor 106, variable orifice valve 110 had to open from a completely closed state. In this way, processor 126 can act to constantly and actively regulate the pressure using the always at least partially open variable orifice valve and the always on pump to maintain target pressure in inflatable bladder 104. By maintaining the target pressure in inflatable bladder 104, processer 126 ensures that there is a constant pressure applied on the limb of a user by limb occlusion cuff 102 during muscle expansion and contraction during use.

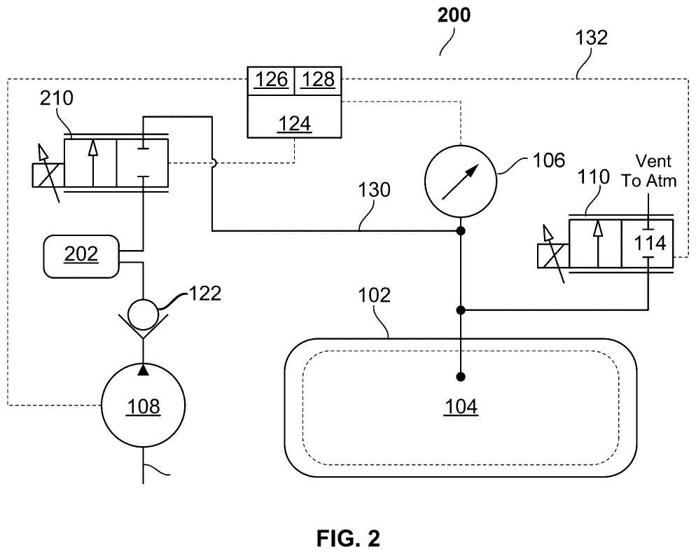

Referring now to FIG. 2, a schematic diagram of a compression system 200 in accordance with another embodiment is shown at 200. Similar to the compression system shown with relation to FIG. 1, compression system 200 comprises limb occlusion cuff 102 having an inflatable and deflatable bladder 104, pressure sensor 106, pump or fluid source 108, variable orifice valve 110, controller 124, processor 126, and memory 128. As previously discussed, variable orifice valve 110 can be a proportional valve. As shown in the embodiment of FIG. 2, a second variable orifice valve 210 and accumulator 202 can be employed. The second variable orifice valve 210 may also be a proportional valve.

As discussed with relation to FIG. 1, limb occlusion cuff 102 can be in communication with the controller 124 and coupled to pump or fluid source 108 such that controller 124 actuates pump or fluid source 108 to an “on” position to provide fluid flow to the bladder 104, thus inflating the bladder 104. Pressure sensor 106 is configured to generate a signal as a function of the pressure in bladder 104. As discussed above, inflation and deflation of bladder 104 causes limb occlusion cuff 102 to change size and exert a pressure on the limb of the user to which limb occlusion cuff 102 is affixed. As such, by sensing the pressure of bladder 104, pressure sensor 106 can be considered to read the pressure applied by limb occlusion cuff 102 itself.

In this embodiment, variable orifice valve 110 is a first proportional valve and can be coupled with or in communication with each of pump 108, controller 124, pressure sensor 106, bladder 104, variable orifice valve 210 (which may be a second proportional valve 210), and accumulator 202.

Both first proportional valve 110 and second proportional valve 210 can, in some embodiments, be two-ported direction valves, but a person of skill in the art would understand that other types of directional valves may be used as appropriate, including three-position, four-way, closed-center, and bi-directional valves. In operation, proportional valve 110 is configured to receive instructions from controller 124, pressure sensor 106, or both to release fluid from bladder 104. The release of fluid from bladder 104 reduces the pressure within bladder 104 and allows limb occlusion cuff 102 to maintain a constant occlusion pressure on the limb of a user regardless of the force exerted by the user's muscle on cuff 102.

In this embodiment, second proportional valve 210 can be in communication with the accumulator 202 and pump 108. In this way, second proportional valve 210 can control fluid flow into bladder 104, and first proportional valve 110 can control fluid flow out of bladder 104. Thus, first proportional valve 110 vents to the atmosphere at 114, whereas second proportional valve 210 provides fluid to bladder 104 and does not vent to the atmosphere (or to any other appropriate fluid reservoir). Accumulator 202 is configured to store fluid which has already been pressurized, and to provide such pressurized fluid to second proportional valve 210. By directing pressurized fluid through second proportional valve 210, limb occlusion cuff 102 can inflate faster, so that compression system 200 avoids the delay of pressurizing the fluid via direct connection to the pump (in second proportional valve 210) prior to routing fluid to bladder 104 of limb occlusion cuff 102. Storage of pressurized fluid in accumulator 202 can thus also help to decrease the size of pump 108. Compression system 200 thus can inflate bladder 104 of limb occlusion cuff 102 more readily in response to changes in pressure in limb occlusion cuff 102 caused by the flexion and extension of the muscles of a user that are adjacent to compression system 200 during use thereof. By increasing the speed with which compression system 200 can respond to such changes in pressure, compression system 200 is able to exert a force on a limb of a user that remains constant at a desired pressure and/or within a desired pressure range, the desired pressure being a desired percentage of a limb occlusion pressure of the limb of the user, and the desired pressure range including said desired percentage of a limb occlusion pressure of the limb of the user.

Processor 126 and controller 124 are in communication with first proportional valve 110 and second proportional valve 210 to control the pressure inside of bladder 104 of limb occlusion cuff 102. Pressure sensor 106 can be in communication with processor 126, which can analyze the sensed pressure data to determine whether the pressure in bladder 104 should be increased or decreased. Increasing or decreasing the pressure in bladder 104 allows compression system 200 to achieve a desired amount of applied pressure on the user by limb occlusion cuff 102 for achieving a desired amount of blood flow restriction on the user.

In this embodiment, processor 126 can be programmed to maintain a constant pressure during use of the limb occlusion cuff 102 despite that during use of limb occlusion cuff 102, the user's muscle contractions displace volume of limb occlusion cuff 102, which, absent a pressure autoregulation mechanism, would cause the pressure in limb occlusion cuff 102 to rise and fall. As such, to combat this and maintain a constant force or pressure applied by limb occlusion cuff 102, processor 126 can be programmed to provide signals to first proportional valve 110, second proportional valve 210 (which controls the pressure transfer from accumulator to bladder 202), and pump 108 so as to maintain a target pressure in inflatable bladder 104, the target pressure of inflatable bladder 104 being configured such that limb occlusion cuff 102 exerts a desired percentage of a limb occlusion pressure on a limb of a user of compression system 200. The desired percentage of the limb occlusion pressure may be a percentage of limb occlusion pressure value between approximately thirty percent, plus or minus five percent, to eighty percent, plus or minus five percent, of the user's limb occlusion pressure. In some implementations, processor 126 can be programmed to provide signals to first proportional valve 110, second proportional valve 210 (which controls the pressure of the fluid exiting the accumulator 202), and pump 108 so as to maintain a target pressure in bladder 104 such that limb occlusion cuff 102 exerts a desired percentage of a limb occlusion pressure on a user's limb that between approximately thirty percent, plus or minus five percent, to fifty percent, plus or minus five percent, of the user's limb occlusion pressure. In further implementations, processor 126 can be programmed to provide signals to first proportional valve 110, second proportional valve 210 (which controls the pressure in the accumulator 202), and pump 108 so as to maintain a pressure in bladder 104 such that limb occlusion cuff 102 exerts a desired percentage of a limb occlusion pressure on a limb of a user of compression system 200 that is between approximately fifty percent, plus or minus five percent, to eighty percent, plus or minus five percent, of the user's limb occlusion pressure. As an example, if the user's limb occlusion pressure is 140 mmHg, the processor 126 can be configured to signal pump or fluid source 108, first proportional valve 110, or both, so that cuff limb occlusion cuff 102 exerts a pressure of between 65 mmHg and 75 mmHg, or between approximately forty six and fifty four percent of the limb occlusion pressure, on the limb of the user to which limb occlusion cuff 102 is affixed.

In this embodiment, when a user's muscle expands, the processor 126 can signal first proportional valve 110 to open to a specified size based on the internal pressure of the limb occlusion cuff 102, as determined (at least in part) by the reading of the pressure of inflatable bladder 104 by pressure sensor 106, as discussed herein. First proportional valve 110 can be configured to open a relatively small amount if the difference between the sensed pressure of inflatable bladder 104 and the target pressure of inflatable bladder 104 is small, but if the pressure difference between the sensed pressure of inflatable bladder 104 and the target pressure of bladder 104 necessary for limb occlusion cuff 102 to exert the desired percentage of the limb occlusion pressure on a limb of the user is large, processor 126 can command the first proportional valve 110 to open relatively more and vent additional fluid (e.g., air or liquid) to the atmosphere (or to another appropriate fluid reservoir). Furthermore, processor 126 can signal second proportional valve 210 to provide fluid to bladder 104 to increase the pressure in bladder 104 during user muscle contraction. Second proportional valve 210 can be configured to provide a relatively small amount of fluid to bladder 104 if the difference between the sensed pressure of inflatable bladder 104 and the pressure of inflatable bladder 104 required so that limb occlusion cuff 102 exerts the desired percentage of the limb occlusion pressure on the limb of the user is small (and the sensed pressure of inflatable bladder 104 is below the target pressure of inflatable bladder 104). Conversely, if there is a large difference between the sensed pressure of inflatable bladder 104 and the target pressure of inflatable bladder 104 required so that limb occlusion cuff 102 exerts the desired percentage of the limb occlusion pressure on the limb of the user (and the sensed pressure of inflatable bladder 104 is below the target pressure of inflatable bladder 104), processor 126 can signal second proportional valve 210 to provide a relatively large amount of fluid to inflatable bladder 104.

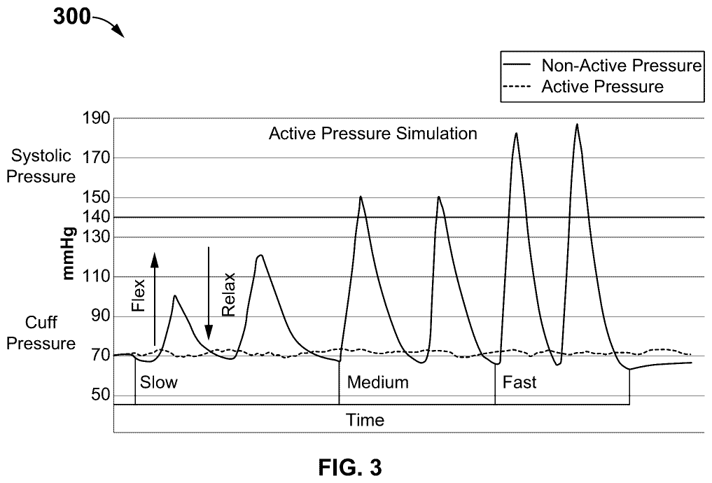

With reference now to FIG. 3 an active pressure simulation graph in accordance with exemplary embodiments are shown at reference numeral 300. The graph shows pressure versus time for a user wearing a BFR device in which an inflatable bladder (e.g., inflatable bladder 104 of FIG. 1) is configured to maintain a target pressure such that the BFR device (e.g., limb occlusion cuff 102 of FIG. 1) is configured to exert a pressure on a limb of the user equal to fifty percent of the limb occlusion pressure (in this example, corresponding to 70 mmHg,). In FIG. 3, the data of a user wearing a BFR device with active pressure management/monitoring on the simulated muscle (dashed line) relative to pressure versus time is plotted against that of a user wearing a BFR device pressurized to fifty percent occlusion without active pressure management/monitoring on the muscle to which the BFR device is affixed (solid line). In the graph, each peak represents a single repetition of a motion by the user (e.g., a bicep curl). Two repetitions of each speed are represented in the set. As can be seen, an active pressure management/monitoring device as described in the embodiments herein maintains a target pressure in an inflatable bladder such that the pressure exerted on the limb of the user by the system remains within a narrow range around the desired percentage of the limb occlusion pressure (e.g., 70 mmHg in FIG. 3), without rising above limb occlusion pressure (shown by the thick solid line at 140 mmHg) or dropping significantly below the desired percentage of the limb occlusion pressure and degrading the therapy.

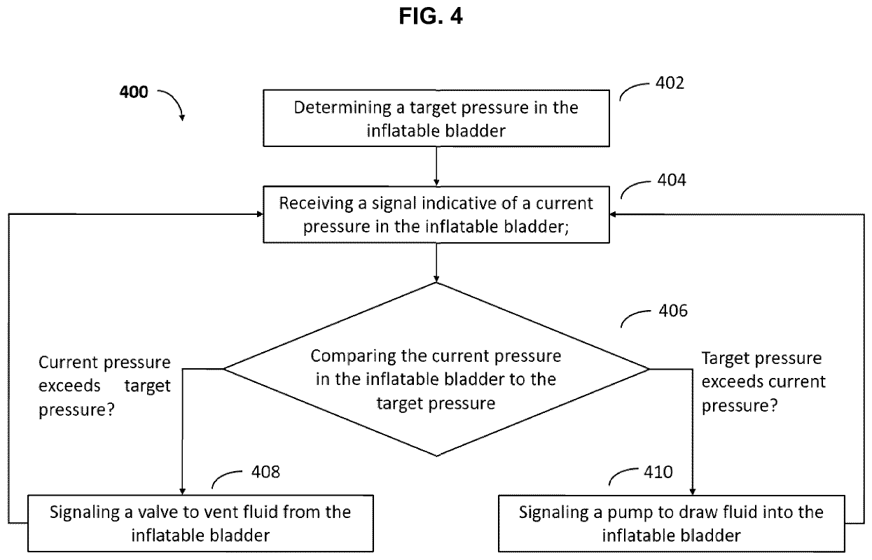

Referring now to FIG. 4 a flowchart illustrating a process for controlling a pressure inside of a cuff in accordance with some example embodiments as described in FIGS. 1 and 2 is shown generally at 400. The method can include determining a target pressure in the inflatable bladder, such as inflatable bladder 104 of FIGS. 1 and 2, at step 402. As described herein, the target pressure in inflatable bladder 104 can be selected such that a limb occlusion cuff in which the bladder is contained, such as limb occlusion cuff 102 of FIGS. 1 and 2, exerts a pressure corresponding to a desired percentage of an occlusion pressure on the limb of a user. The target pressure can be input and stored in the processor and memory, as discussed above with respect to FIGS. 1 and 2.

The method can further include receiving a signal indicative of a pressure in the cuff during use of the inflatable bladder in step 404. The signal can be received at the processor, such as processor 126 of FIGS. 1 and 2, and controller, such as controller 124 of FIGS. 1 and 2, using the pressure sensor, such as pressure sensor 106 of FIGS. 1 and 2.

The method can further include comparing the current pressure in the inflatable bladder to a target pressure of the inflatable bladder that must be established so that the limb occlusion cuff exerts the desired percentage of the limb occlusion pressure on the limb of the user, as in step 406. Based on the result of the comparison, and in particular, if the comparison indicates that the current pressure in the inflatable bladder exceeds the target bladder pressure, the method can further comprise signaling a variable orifice valve to vent fluid from the inflatable bladder to maintain the target pressure, as in step 408. The variable orifice valve can be a proportional valve, as described herein. More specifically, in operation, when a user's muscle expands, the processor can signal the proportional valve to open to a specified size based on the internal pressure of the bladder, which, as described, serves as a proxy to the pressure exerted by the limb occlusion cuff on the limb of a user. The proportional valve can be configured to open a relatively small amount if the difference between the sensed pressure and the necessary bladder pressure is small, but if the pressure difference between the sensed pressure and the necessary bladder pressure is large, the processor can command the proportional valve to open relatively more and vent additional air to the atmosphere. The proportional valve, together with the pump can maintain a pressure in the inflatable bladder (i.e., target pressure) in the limb occlusion cuff that is a percentage of limb occlusion pressure value between approximately thirty percent, plus or minus five percent, to eighty percent, plus or minus five percent, of the user's limb occlusion pressure. In some implementations, the proportional valve, together with the pump can maintain a pressure (i.e., target pressure) in the inflatable bladder such that limb occlusion cuff maintains a pressure on a limb of a user that is a desired percentage of limb occlusion pressure between approximately thirty percent, plus or minus five percent, to fifty percent, plus or minus five percent, of the user's limb occlusion pressure. In further implementations, the proportional valve, together with the pump can maintain a pressure (i.e., target pressure) in the inflatable bladder such that limb occlusion cuff maintains a pressure on a limb of a user that is a percentage of limb occlusion pressure between approximately fifty percent, plus or minus five percent, to eighty percent, plus or minus five percent, of the user's limb occlusion pressure. As an example, if the user's limb occlusion pressure is 140 mmHg, the processor is configured to signal the pump 108, proportional valve 110, or both, so that the cuff exerts a force of between 65 mmHg and 75 mmHg, or between approximately forty-six and fifty four percent of the limb occlusion pressure on the limb of a user.

If, on the other hand, the comparison indicates that the current pressure in the inflatable bladder is less than the target pressure, the method can further comprise signaling a pump or fluid source to draw fluid into the inflatable bladder to thereby increase the pressure within the bladder and maintain the target pressure, as in step 410.

In embodiments, the variable orifice valve can be completely shut, and the pump can intermittently turn on, or the variable orifice valve can be always open, and the pump can run continuously such that the only point of control resides in the variable orifice valve. In embodiments, the pump pressurizes the cuff and multiple on/off solenoid valves with different orifice sizes may be used such that certain valves are actuated when certain pressures are present in an effort to return to target pressure without overshooting or taking too much time.

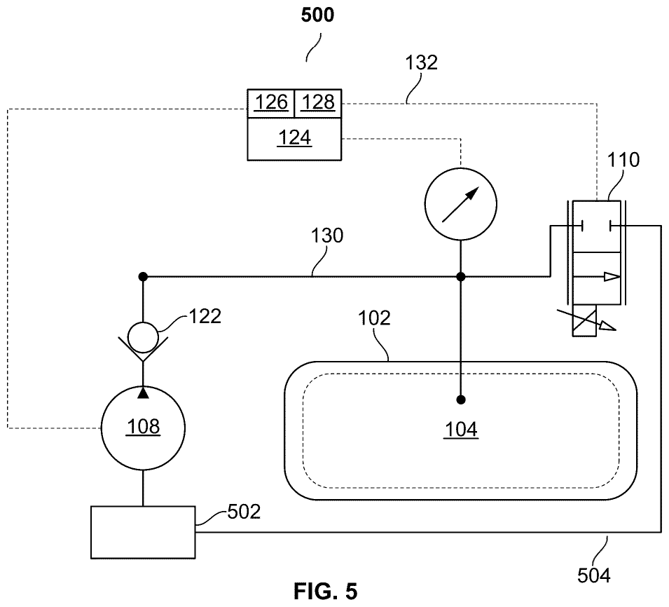

Referring now to FIG. 5 a schematic diagram of a hydraulic compression system 500 is shown. In this embodiment, pump or fluid source 108 is in hydraulic communication with hydraulic reservoir 502, which is further coupled to proportional valve 110 making the compression system a “closed system”. In operation, pump 108 receives a fluid (e.g., water or oil) from reservoir 502 and pumps the fluid to limb occlusion cuff 102 based on signals from controller 124. A return line 504 connected to proportional valve 110 is also provided.

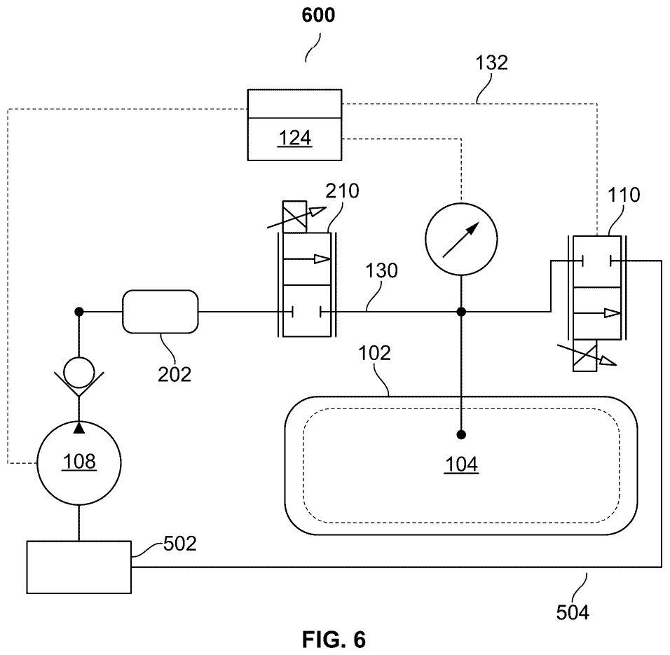

Referring now to FIG. 6, a schematic diagram of a hydraulic compression system 600 with an accumulator in accordance with another embodiment if is shown. Similar to the compression system shown with relation to FIGS. 1 and 2, compression system 600 comprises limb occlusion cuff 102 having inflatable and deflatable bladder 104, pressure sensor 106, pump 108, first proportional valve 110, second proportional valve 210, controller 124, processor 126, and memory 128. In this embodiment, alternatively, additionally, or both, second proportional valve 210 and accumulator 202 can be employed. In this embodiment, pump 108 is in fluidic communication with hydraulic reservoir 502, which is further coupled to proportional valve 110 making the compression 600 system a “closed system”. In operation, pump 108 receives a fluid (e.g., water or oil) from reservoir 502 and pumps the fluid to the accumulator 202 based on signals from controller 124. The fluid received by accumulator 202 may be appropriately pressurized before being routed to inflatable bladder 104 to adjust the current pressure of the inflatable bladder based on a difference between the current pressure and a target pressure of the inflatable bladder 104, as described herein. A return line 504 connected to the proportional valve is also provided.

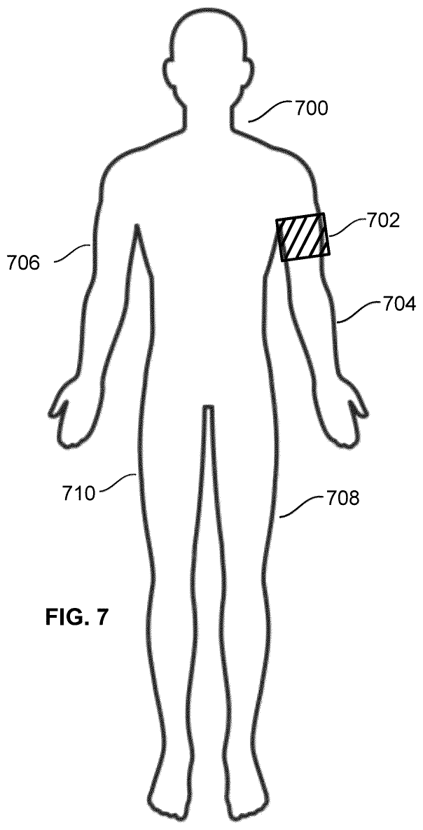

Referring now to FIG. 7, a user 700 of a limb occlusion cuff 702 is shown. Limb occlusion cuff 702 may be a limb occlusion cuff in accordance with any of the embodiments described herein. In FIG. 7, limb occlusion cuff 702 is disposed on the right arm 704 of user 700. A limb occlusion cuff 702 in accordance with the embodiments described herein may be disposed on any limb of user 700, including left arm 706, right leg 708, or left leg 710. As described above, when limb occlusion cuff 702 is disposed on a limb of user 700, limb occlusion cuff 702 is configured to actively maintain a constant percentage of an occlusion pressure within the limb, including during contraction (e.g., flexing) and extension (e.g., relaxing) one or more muscles adjacent (e.g., affected by the applied pressure from the limb occlusion cuff 702) the limb occlusion cuff 702. In certain implementations, limb occlusion cuff 702 is configured to actively maintain a pressure between approximately thirty percent, plus or minus five percent, and eighty percent, plus or minus five percent, of the occlusion pressure of the limb of user 700 on which limb occlusion cuff 702 is disposed, including during contracting and elongating of the one or more muscles adjacent the limb occlusion cuff 702. In further implementations, limb occlusion cuff 702 is configured to maintain a pressure between approximately thirty percent, plus or minus five percent, and fifty percent, plus or minus five percent, of the occlusion pressure of the limb of user 700 on which limb occlusion cuff 702 is disposed, including during contracting and elongating of the one or more muscles adjacent the limb occlusion cuff 702. In some implementations, limb occlusion cuff 702 is configured to maintain a pressure between approximately fifty percent, plus or minus five percent, and eighty percent, plus or minus five percent, of the occlusion pressure of the limb of user 700 on which limb occlusion cuff 702 is disposed, including during contracting and elongating of the one or more muscles adjacent the limb occlusion cuff 702.

Referring now to FIGS. 8A-8C, there is illustrated a simplified schematic diagram showing the operational of an exemplary variable orifice valve 800 (“valve 800”) in accordance with certain embodiments. Valve 800 may be, for example, valve 110 of FIG. 1, and may further be a proportional valve. A person of skill in the art (“POSITA”) would understand that valve 800 is an extremely simplified variable orifice valve, and that a variable orifice valve used in limb occlusion cuffs in accordance with embodiments described herein could contain other components, including, but not limited to, seals, actuators thermal compensators, and pressure compensators. Such additional components and their functions are not illustrated in FIG. 8, but a POSITA would understand the components of variable orifice valve 800 as described herein could be found in many variable orifice valves that could be used in embodiments of the limb occlusion cuffs described herein. Variable orifice valve 800 comprises solenoid 802, spring 804, piston 806, inlet 808, and outlet 810. As described above, fluid is configured to flow through variable orifice valve 800 during the active regulation of the pressure of a limb occlusion cuff, such as limb occlusion cuff 102 of FIG. 1, in which variable orifice valve 800 can be included. Variable orifice valve 800 may be configured to open based on signals received from a sensor, such as pressure sensor 106 of FIG. 1. As described above, pressure sensor 106 of FIG. 1 can be placed along a pneumatic line, such as pneumatic line 130 of FIG. 1, between variable orifice valve 800 and an inflatable bladder, such as bladder 104 of FIG. 1, at a first distance away from bladder 104. Pressure sensor 106 can further be placed along the pneumatic line 130 between variable orifice valve 110 and bladder 104 such that a second distance between variable orifice valve 110 and pressure sensor 106 is greater than the first distance between pressure sensor 106 and bladder 104 so as to provide an accurate reading of the current pressure in bladder 104, thus facilitating closed-loop control of the pressure in limb occlusion cuff 102.

The degree to which variable orifice valve 800 opens can be proportional to a signal received from the controller the signal being indicative of a current pressure of a bladder of a limb occlusion cuff, such as bladder 104 of limb occlusion cuff 102, as sensed by pressure sensor 106, all of FIG. 1. FIG. 8A shows variable orifice valve 800 in a closed configuration, in which piston 806 blocks the path between inlet 808 and outlet 810. In response to a signal, such as a signal received from pressure sensor 106 of FIG. 1, solenoid 802 and spring 804 cooperate to move piston 806 so that the pathway or orifice between inlet 808 and outlet 810 partially opens, such as in FIG. 8B. In the embodiment of FIG. 8B, piston 806 partially obstructs the pathway or orifice between inlet 808 and outlet 810. In the embodiment of FIG. 8B, the signal received from the pressure sensor instructs the variable orifice valve 800 to open a relatively small degree compared to the embodiment of FIG. 8C. In FIG. 8C, responsive to a received signal, solenoid 802 and spring 804 cooperate to move piston 806 such that the pathway between inlet 808 and outlet 810 is unobstructed.

As one example, a pressure sensor such as pressure sensor 106 of FIG. 1 may instruct variable orifice valve 800 to open to the extent shown in FIG. 8B if the current pressure of the bladder of the limb occlusion cuff to which variable orifice valve 800 is affixed exceeds a target pressure by a small amount, as may be the case if a user of such a limb occlusion cuff slightly flexes a muscle that is adjacent to the limb occlusion cuff. As another example, a pressure sensor may instruct variable orifice valve 800 to open to the extent shown in FIG. 8C if the current pressure of the bladder of the limb occlusion cuff to which variable orifice valve 800 is affixed exceeds a target pressure by a large amount, as may be the case if a user of such a limb occlusion cuff complete flexes a muscle adjacent to the limb occlusion cuff. In general, as described above, a controller, such as controller 124 of FIG. 1, may control variable orifice valve 800 such that the variable orifice valve is always at least partially open, i.e., such that piston 806 at most only partially obstructs the pathway between inlet 808 and outlet 810. By keeping variable orifice valve 800 at least always partially open, the pressure of a limb occlusion cuff containing variable orifice valve 800 can be actively regulated, as described above.

Advantageously, described herein are systems and methods for active pressure monitoring with a variable orifice valve and a pump allows for a compression system that continuously maintain a pressure on a limb of a user that is close to a desired pressure (i.e., a desired percentage of limb occlusion pressure), as any pressure above the desired percentage of the limb occlusion pressure does not aid in the therapy and can cause injury to muscle and circulatory system, bruising, nerve damage, and numbness within the area. Such active pressure regulation may be facilitated by a controller of the compression system that controls a variable orifice valve, which may be a proportional valve, using closed-loop control. Active pressure management/monitoring protects against injury from pressures that are too high, but it also gives the fidelity to ensure that the pressure exerted on the limb of a user by the compression system does not drop below the desired percentage of the limb occlusion pressure. When there is not sufficient pressure inside of the cuff, blood is free to flow and reduces the therapeutic effects of the system. These factors create a situation in which staying close to the desired percentage of the limb occlusion pressure is imperative, both for safety and delivery of therapy.

While the present disclosure is described in relation to a wearable compression systems and devices such as a blood flow restriction device, the systems and methods described herein are usable with any medical or therapeutic devices that utilize an inflatable cuff.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A limb occlusion cuff for use in a compression system, the cuff comprising:
an inflatable bladder;
a variable orifice valve coupled to the inflatable bladder via a fluid pathway;
a pump coupled to the inflatable bladder via the fluid pathway;
a pressure sensor disposed along the fluid pathway; and
a controller, the controller comprising:
a processor configured to actively regulate a current pressure in the inflatable bladder.

2. The limb occlusion cuff of claim 1, wherein:
the pressure sensor is configured to generate a signal indicative of the current pressure of the inflatable bladder; and
the processor is configured to perform a comparison between the current pressure of the inflatable bladder and a target pressure of the inflatable bladder.

3. The limb occlusion cuff of claim 2, wherein the processor is configured to actively regulate the current pressure by controlling the variable orifice valve to release fluid to deflate the inflatable bladder if the result of the comparison indicates that the current pressure is greater than the target pressure.

4. The limb occlusion cuff of claim 2, wherein the processor is configured to actively regulate the current pressure by controlling the pump to intake fluid to inflate the inflatable bladder if the result of the comparison indicates that the current pressure is lower than the target pressure.

5. The limb occlusion cuff of claim 2, wherein the processor is configured to actively regulate the current pressure by simultaneously controlling the variable orifice valve to release fluid and/or controlling the pump to intake fluid until the current pressure of the bladder is substantially equal to the target pressure.

6. The limb occlusion cuff of claim 1, wherein the variable orifice valve is a proportional valve, and wherein the proportional valve is coupled bi-directionally to the inflatable bladder.

7. The limb occlusion cuff of claim 1, wherein the target pressure of the inflatable bladder is chosen such that a pressure exerted by the limb occlusion cuff on a limb of a user is below an occlusion pressure of the limb of the user.

8. The limb occlusion cuff of claim 7, wherein the pressure exerted by the limb occlusion cuff on the limb of the user is between thirty percent and eighty percent of the limb occlusion pressure of the limb of the user.

9. The limb occlusion cuff of claim 8, wherein the pressure exerted by the limb occlusion cuff on the limb of the user is between thirty percent and fifty percent of the limb occlusion pressure of the limb of the user.

10. The limb occlusion cuff of claim 8, wherein the pressure exerted by the limb occlusion cuff on the limb of the user is between fifty percent and eighty percent of a limb occlusion pressure of the limb of the user.

11. The limb occlusion cuff of claim 1, wherein:
the variable orifice valve is configured to always be at least partially open during use of the limb occlusion cuff; and
the pump is configured to always be on during use of the limb occlusion cuff.

12. The limb occlusion cuff of claim 1, wherein:
the controller further comprises a memory; and
the target pressure is stored in the memory.

13. The limb occlusion cuff of claim 1, wherein the processor is configured to actively regulate the current pressure by closed-loop control.

14. A method of actively regulating pressure in a limb occlusion cuff of a compression system, the cuff comprising an inflatable bladder, a variable orifice valve coupled to the inflatable bladder via a fluid pathway, a pump coupled to the inflatable bladder via the fluid pathway, a pressure sensor disposed along the fluid pathway, and a controller, the method performed by the controller and the method comprising:
determining a target pressure in the inflatable bladder;
receiving, from the pressure sensor, a signal indicative of a current pressure in the inflatable bladder; and
comparing, via a processor of the controller, the current pressure in the inflatable bladder to the target pressure.

15. The method of claim 14, further comprising, when the comparing indicates that the current pressure in the inflatable bladder exceeds the target pressure, signaling, via the controller, the variable orifice valve to vent fluid from the inflatable bladder.

16. The method of claim 14, further comprising, when the comparing indicates that the current pressure in the inflatable bladder is less than the target pressure, signaling, via the controller, the pump to draw fluid into the inflatable bladder.

17. The method of claim 15, further comprising venting fluid from the inflatable bladder via a proportional valve, the proportional valve being bi-directionally coupled to the inflatable bladder.

18. The method of claim 14, further comprising comparing, via the processor of the controller, the current pressure in the inflatable bladder to the target pressure, the target pressure being chosen so that the limb occlusion cuff exerts a pressure on a limb of a user that is below an occlusion pressure of the limb of the user.

19. The method of claim 14, further comprising keeping the variable orifice valve always at least partially open and/or keeping the pump always on during use of the limb occlusion cuff.

20. The method of claim 14, further comprising:
drawing fluid in through the pump when a user of the limb occlusion cuff flexes a muscle adjacent to the cuff; and
venting fluid out through the valve when the user of the limb occlusion cuff extends the muscle adjacent to the cuff.
